(19) United States
(12) Patent Application Publication
(10) Pub. No.: US 2010/0207711 A1
(43) Pub. Date: Aug. 19, 2010

(54) Capacitive Signal Coupling Apparatus

(76) Inventor: James D. Estes, Arlington, TX (US)

Correspondence Address: WHITAKER, CHALK, SWINDLE & SAWYER, LLP, 3500 CITY CENTER TOWER II, 301 COMMERCE STREET, FORT WORTH, TX, 76102-4186, US

(21) Appl. No.: 12/372,526

(22) Filed: Feb. 17, 2009

(51) Int. Cl. H01P 5/02

(52) U.S. Cl. 333/24 C

(57) ABSTRACT

An instrument assembly for a well casing inspection tool, comprising a main shaft having an extension shaft extending therefrom. An instrument head is supported on bearings proximate one end of the main shaft. The rotating instrument head, which includes sensors for measuring wall thickness and caliper of the well casing, provides continuous 360 degree scanning of the interior of the well casing to obtain detailed measurements of the well casing. A motor drives the rotating instrument head through a gear train. A mandrel supported by the main shaft includes exciter coils for wall thickness, caliper, and permeability measurements. A capacitive slip ring couples signals between the rotating instrument head and stationary circuits in the instrument assembly.

### BACKGROUND OF THE INVENTION

The present application is related to co-pending U.S. patent application by the same inventor entitled “Casing Inspection Logging Tool,” filed concurrently herewith.

1. Field of the Invention

The present invention generally relates to down-hole oil and gas logging instruments and more particularly to logging tools for measuring the inside diameter and wall thickness of the well casing in oil and gas wells and in other applications where these parameters of such pipe must be inspected and measured.

2. Background and Description of the Prior Art

Well casings and other metallic pipe (“casing”) used in down-hole drilling for oil and gas and, more recently, for geothermal fluids, typically encounters severe conditions of chemical, temperature and pressure phenomena. These conditions subject the casing to corrosion and other types of deterioration from the fluids and other caustic substances that flow through them or which exist outside but next to the casing. These conditions necessitate periodic inspection of the interior of these casings through measurements of various parameters of the casings such as the inside diameter (“caliper”) of the casing and the wall thickness of the casing. For example, as corrosion and pitting removes material from the inside surface of the casing, its wall thickness diminishes and its interior diameter increases, resulting in a weaker casing that can no longer withstand the internal pressure within the well casing. Such a casing may rupture or eventually leak caustic or toxic materials into the surrounding strata, or admit contaminating substances from the rock strata next to the casing.

Apparatus and methods for measuring the caliper and wall thickness of well casings and pipe used in oil and gas wells and pipelines are well known. Older, mechanical caliper devices were supplanted by more versatile and accurate devices that employed electromagnetic operating principles. Yet, effective as these instruments were, the measurements provided were often limited by the relatively slow speeds of the sensors in them, a limited range of physical movement of the sensors, and the inability to take measurements at more than a small number of data points along the interior of the casing. For example, some earlier logging tools for measuring wall thickness and/or caliper, and in some cases permeability of the casing itself, included U.S. Pat. No. 2,992,390, DeWitte, U.S. Pat. No. 4,708,204, Stroud, United Kingdom Patent No. GB 2 037 439, Smith, and U.S. Pat. No. 5,299,359, Estes. While the Smith patent, incorporated herein by reference, contains a concise discussion of the use of permeability data to refine wall thickness approximations based on phase shift measurements, all of these references employed non-rotating transmit and/or receive coils that longitudinally traversed the interior of the well casing as the logging tool was withdrawn to the surface. The limitations of these earlier designs, considered successful in their era, resulted in measurement data that approximated the condition of the pipe walls but often did not reveal sufficient detail and accuracy. As a result, pipe having serious but undetected faults may be left in the well, risking loss or contamination of fluids within the casing, contamination of surrounding strata, or damage or injury to equipment or personnel. Moreover, pipe replacements and repairs that were unnecessary may be performed—at unnecessary costs in money and lost time—because of the uncertainty in the measurements that, in many cases, are little more than of a spot-checked character.

Several recent attempts to solve these problems are disclosed in the following patents. U.S. Pat. No. 6,404,189, issued to Kwun, et al. is directed to a system comprising a magnetostrictive sensor unit, a data storage unit, and a plurality of magnetostrictive sensor probes that are positioned on an in-line inspection vehicle that travels within the pipeline casing. Transmitting and receiving probes are attached to the inline inspection vehicle and maintain a constant distance from the inside diameter of the pipe wall. The transmitting probe generates waves that propagate in both directions around the circumference of the pipe wall to a receiving probe spaced 180° apart from the transmitting probe.

U.S. Pat. No. 6,772,637, issued to Bazarov, et al, is directed to an inspection pig carrying circular arrays of transducers centered on the longitudinal axis of the inspection pig. The cycle time of the monitoring transducers is set as a function of at least two values of the pig velocity determined during its travel, during which the monitoring transducers are interrogated at a rate between 200 and 2000 cycles of interrogation. The method is devised to provide accurate measurement data yet avoiding overflow of the data storage module during slow movements of the pig and disturbance of the cycle time of the monitoring transducers during short term changes in the pig velocity.

U.S. Pat. No. 6,848,313 issued to Krieg, et al., is directed to detecting defects in pipelines using ultrasound techniques applied to first and second circular arrays of transducers which travel through the pipeline along the longitudinal axis of the casing. The two arrays of sensors are radially offset to provide full circumferential coverage of the interior of the casing. Individual sensors of each array may be individually controlled. Defects in the pipe wall are determined by evaluation of the acoustical signals reflected by different boundary regions wherein the reflected signals contain phase information responsive to such conditions of the casing wall such as corrosion, pitting and cracks.

Four patents issued to Harthorn, et al., including U.S. Pat. Nos. 6,904,818; 7,107,863; 7,082,822, and 7,104,125 are directed to methods and apparatus for inspecting offshore drilling risers submerged to subsea wellheads in situ. The inspection unit for these devices generally employs two arrays of sensors, wherein the sensing transducers are disposed at equal 90° intervals around a circle. The transducers utilize ultrasonic or magnetic particle imaging techniques for inspecting the welds of the casing and measuring the thickness of the casings. A dual array of transducers is used for inspecting the welds and a single array of transducers is used to measure the thickness of the casing. In some of the patents, the sensor arrays may be rotated within a range of approximately plus or minus 180° for full circumference measurements. In one of the patents, the array of transducers is non-rotatable.

In the Harthorn, et al,,patents, the '818 patent employs ultrasonic techniques and both arrays of sensor transducers are rotatable through a range of plus or minus 180°. The '863 patent, which is similar to the '818 patent, uses magnetic particle imaging techniques applied after a wire brush cleaning, and enables viewing of the effect of a magnetic field on the weld being inspected using a video inspection device. The characteristics of the weld are made visible by dispensing a magnetic particle imaging medium which includes fluorescent particles to enable viewing the patterns produced by the magnetic field. The '125 patent of Harthorn, et al. contains claims for the apparatus for performing the methods claimed in the '822 patent.

U.S. Pat. No. 7,111,516, issued to Bazarov, et al. is directed to an inspection device for in-tube monitoring of main pipelines using ultrasonic wall thickness metering. Ultrasonic pulses are transmitted and received by corresponding transducers and the reflected signals from the interior and exterior walls of the casing is analyzed to produce a measurement of the thickness of the wall casing. A controlled voltage reference source provides separate voltage references for use in analyzing the reflective signals from the inside and from the exterior side of the wall casing. The method includes the aforementioned process (see the '637 patent above) for coordinating the cycle time of the monitoring transducers with the velocity of the inspection pig.

While the foregoing patents disclose instruments that employ a variety of transducer types and configurations in an effort to improve the efficiency and accuracy of well casing measurements, none of them appear to achieve high resolution data for the entirety of the casing interior and high speed measurement operation, in an instrument that is also low in cost. As a group, they remain less than fully successful at overcoming such problems as too few samples to provide the needed accuracy, missed anomalies in the casing that turn out to be crucial, limitations of temperature in very deep wells, high cost and complexity, less than robust reliability, etc. What is needed is an apparatus than can provide caliper and wall thickness measurement data that is more detailed and is available rapidly, yet is obtainable at lower cost for a suitable instrument and the resources used up in providing the needed data.

### SUMMARY OF THE INVENTION

Accordingly, there is disclosed herein a casing inspection logging tool that incorporates a rotating sensor head that spins on its axis within the casing. The rotating sensor head contains the necessary coils and electronics for making continuous, high speed caliper and wall thickness measurements from the interior of the casing. All of the sensing required for the measurements is accomplished by the rotating head The logging tool provides a greater number of data points produced by relatively smaller receiver coils placed very close to the casing wall, resulting in high resolution of casing anomalies and such defects as corrosion, pitting, fractures, material voids, and the like. The logging tool of the present invention may also measure casing wall permeability for refining the wall thickness data.

A principle advantage of the present invention is its greater accuracy, which reveals far more information about the condition of the casing than heretofore available. Moreover, this information is provided more rapidly, and in the first pass through the casing, which negates the need to make repeat measurements. Other important advantages include simpler construction, operation at higher temperatures, more rugged design, high reliability, and lower cost to manufacture and to use in the field.

In one embodiment of the invention, there is provided an instrument assembly for a well casing inspection tool, comprising a main shaft having a hollow portion and an extension shaft extending axially from a first end of the main shaft, and an instrument head concentric with and configured for free rotation about the extension shaft and proximate the first end of the main shaft. The rotating instrument head provides continuous 360 degree scanning of the interior of the well casing to obtain detailed measurements of the well casing.

In another embodiment of the invention, there is provided a well casing inspection instrument, comprising an elongated instrument body having a longitudinal axis, a main shaft supported in the elongated body along said axis, a motor mounted in the main shaft and aligned along the longitudinal axis, a rotating sensor assembly supported by a bearing assembly on an extension of the main shaft and driven by the motor; wherein the rotating sensor assembly provides continuous 360 degree scanning of the interior of the well casing to obtain detailed measurements of the well casing.

In another embodiment of the invention, there is provided a casing inspection tool, comprising a tool body, a main shaft having a first diameter and a first end and disposed in the tool body, the main shaft having a hollow first portion proximate the first end; an extension shaft of smaller diameter extending longitudinally from the first end of the main shaft; and a rotating sensor assembly supported on the extension shaft by a bearing assembly and driven by a DC brushless motor supported within the hollow portion of the main shaft, the sensor assembly further including a high resolution wall thickness sensor for scanning the entire wall of the casing to obtain continuous detailed wall thickness data, and a high resolution caliper sensor for scanning the entire wall of the well casing to obtain continuous detailed caliper data.

In another embodiment of the invention, a signal coupling apparatus is provided for coupling electrical signals across a gap between two closely mounted assemblies. The apparatus comprises first and second flat conductive rings disposed on respective first and second planar substrates, the conductive rings centered on a common axis and disposed in a facing, spaced apart relationship across a defined gap, wherein the conductive rings form respective plates of a capacitor In several aspects of the inventions, the instrument head includes sensors for measuring wall thickness and caliper of the well casing, and a motor drives the rotating instrument head through a gear train. The rotating instrument head is supported on bearings on the extension shaft. A mandrel supported by the main shaft includes exciter coils for wall thickness, caliper, and permeability measurements. A capacitive slip ring couples signals between the rotating instrument head and stationary circuits in the instrument assembly.

### BRIEF DESCRIPTION OF THE DRAWINGS

FIG. 1 illustrates an exploded view of a portion of a casing inspection tool including an embodiment of the present invention;

FIG. 2 illustrates a conceptual cross section view of a casing inspection tool according to one embodiment of the present invention;

FIG. 3A illustrates a lateral cross section view of a rotating portion of the embodiment of FIGS. 1 and 2;

FIG. 3B illustrates a lateral cross section view of an alternate embodiment of the rotating portion of the embodiment of FIGS. 1 and 2;

FIG. 4 illustrates a simplified circuit diagram of circuits in the embodiment of FIGS. 1 and 2;

FIG. 5 illustrates a simplified circuit diagram of caliper sensor circuits of the rotating portion of the embodiment of FIG. 3;

FIG. 6 illustrates coil response waveforms of the caliper sensor circuits of FIG. 5;

FIG. 7 illustrates analog and digital signals of the caliper sensor circuits of FIG. 5;

FIG. 8 illustrates a simplified circuit diagram of wall thickness circuits of the rotating portion of the embodiment of FIG. 3;

FIG. 9 illustrates a graph of the response characteristic of the wall thickness circuit of FIG. 8;

FIG. 10 illustrates a simplified schematic diagram of a permeability measurement circuit of the embodiment of FIGS. 1 and 2;

FIG. 11 illustrates a graph of the permeability characteristic of the circuit of FIG. 10;

FIG. 12 illustrates a simplified circuit diagram of an exciter circuit for use in the embodiment of FIGS. 1, 2 and 3;

FIG. 13 illustrates a simplified circuit diagram of a power coupling circuit for use in the embodiment of FIGS. 2 and 3; and

FIG. 14 illustrates one embodiment of a capacitive slip ring coupling device according to the present invention.

### DETAILED DESCRIPTION OF THE INVENTION

By way of introduction, the present invention is an instrument assembly for a well casing inspection tool. The invention includes sensing coils for making measurements of characteristics of the well casing that are disposed in a rotating portion of the tool to enable continuous 360 degree scanning of the interior of a well casing. By configuring the sensor head to place the sensing coils close to the well casing inner surface and to continuously scan the inner wall of the well casing at relatively high speed, the instrument obtains high resolution data for the entire casing, not just sampled data at regular but spaced apart intervals.

The instrument for a well casing inspection tool to be described herein comprises an elongated cylindrical body or mandrel that surrounds a stationary main shaft. The longitudinal axis of the main shaft defines the longitudinal axis of the instrument. Extending axially (along the longitudinal axis) from a first end of the main shaft is a smaller diameter extension of the main shaft, which functions as an axial support shaft for the rotating sensor head. The sensor head is configured for rotating or spinning freely about the extension shaft and proximate the first end of the main shaft. The assembly further comprises an electric motor having an axial output shaft and disposed within a hollow portion of the main shaft near the first end of the main shaft. The motor is configured for spinning the rotating instrument head via a gear train having a counter-shaft that couples the rotating instrument head to the electric motor axial output shaft. In a preferred embodiment, the motor shaft and the rotating instrument head are aligned along the same axis, which is also coincident with the longitudinal axis of the instrument assembly. This construction enables the rotating instrument head to scan successive small portions of the interior of a well casing at high speed to provide high resolution measurements of the internal dimensions (i.e., well casing inside diameter or “caliper”) and wall thickness or other parameters of interest in a well logging application.

Measurements are made in the instrument assembly by interpreting the response of the sensor coils (also called receiver coils) to varying magnetic fields established by several exciter coils ( also called transmitter coils) installed on the non-rotating mandrel portion of the instrument. The exciter coils, when energized by alternating currents of an appropriate frequency for the particular measurement, generate corresponding magnetic fields in the vicinity of the tool. The magnetic fields tend to be established in the well casing and their amplitude and phase are detected by the sensor coils located in the rotating sensor head. Thus, the sensor coils may said to be activated by the exciter coils. The mandrel of the instrument assembly disclosed herein includes a 60 Hz exciter coil, a 20 KHz exciter coil, and may include a 120 Hz permeability (receiver) coil to facilitate obtaining measurements of the permeability of the well casing for correcting the wall thickness measurements. Such corrections for permeability may be used to improve the accuracy of the wall thickness measurements.

The insights that led to the present invention included realizing that, for wall thickness measurements, (a) the large receiver coil in conventional tools could be replaced by a very small coil that is positioned very close to and configured to read only a small area portion of the well casing; and (b) the small receiver coil could be configured to scan the casing by rotating or spinning it entirely and continuously around the interior of the casing. Similarly, for the internal diameter measurements, it was realized that substantially enhanced performance would result from (c) operating an eddy current sensor at high frequency, as it is also (d) continuously scanned past the casing wall at high speed. These insights led to a new logging tool configuration as described herein.

A number of advantages are realized by the novel structure of a fully rotating or spinning instrument head. By spinning the sensors at high speed past the interior surface of the well casing, a very large number of data points are measured per unit of time as the logging tool is moved through the casing. Measurement of many data points enables high resolution of the caliper and wall thickness dimensions, providing a greatly enhanced image or profile of the topology and condition of the casing interior, along with the precise location of flaws such as corrosion, faults, cracks, leaks, pits, etc. Moreover, the instrument can reliably determine such conditions even in well casing that is flattened or “ovalized” (having an oblong or elliptical cross section). The present invention may be adapted to use in well casing having an inside diameter from five to twenty four inches in diameter.

As will be described, the instrument assembly includes apparatus for measuring both the caliper and wall thickness dimensions of the well casing. This apparatus includes respective electronic circuits coupled to the caliper and wall thickness sensing apparatus for conducting and processing the measurements. The instrument assembly, comprising the elongated cylindrical body, which contains the mandrel and the rotating instrument head combination including their associated constituent components described above, is disposed within a sleeve-like housing. The housing includes a thin-walled stainless steel sleeve and an end portion surrounding the rotating instrument head assembly that is fabricated of a thin-walled ceramic material. The space within the sleeves is oil filled and pressurized, with pressure maintained within limits by a sliding sleeve oil volume compensator. The rotating instrument head is supported on one or more bearings on the extension shaft so that it may rotate freely when driven by the electric motor. Electric power is coupled from within the cylindrical body to the rotating instrument head through a capacitive slip ring assembly. Electrical connections from the rotating instrument head to the non-rotating portion of the instrument assembly may be provided through a capacitive slip ring assembly to be described Other connections from the non-rotating portion of the instrument assembly to the body of the well casing tool may be provided with a feed-through connector such as a 12-pin unit suitable for use at 25 Ksi@400° F. or better.

In a preferred embodiment, the elongated cylindrical body is configured as a tubular mandrel installed over and supported by a non-rotating main shaft that is generally centered on the longitudinal axis of the well casing tool. An extension shaft extends from the first end of the main shaft to provide the axis of rotation of the rotating instrument head. The electric motor may be, for example, a brushless motor turning at 10,000 RPM (revolutions per minute). In one embodiment, for example, the gear train in this example may provide a pair of step-down ratios of 9:18 and 9:24, one gearset at either end of the countershaft, so that the rotating head turns at 1875 RPM, or approximately 31.25 revolutions per second. If the caliper coils are providing measurements at a 20 KHz rate, then the caliper circuit provides approximately 20,000±31.25=640 measurements per revolution of the rotating sensor head 30 during each second, or approximately one measurement every 34 minutes of arc (about one-half degree).

Continuing with this example, if the tool is traveling through the pipe at 75 feet per minute or 75÷60 feet per second=1.25 feet per second=15 inches per second, then ÷640÷15 in=42.66 is the number of measurements per inch of travel along the pipe [in about 67 millisec.]. These 42+ measurements are made within 360 degrees÷15 inches= 1/24th of a revolution or a rotation of the sensor head of about 15 degrees per inch of travel around the inside of the pipe. In a pipe having a 5 inch inside diameter, 15 degrees represents approximately (1/24)×5″×π=15.71÷24 inch of circumference, or about ⅔ inch. ⅔ inch circumference×1 inch of travel=0.667 square inch of area measured per inch of linear travel by 42 measurements, or 0.667÷42=about 0.016 sq. in. per measurement, an area of approximately 0.125 in.×0.125 in. per measurement. This figure provides an indication of the resolution of the measurements.

In operation, 12,000 caliper measurements per second and 120 wall thickness measurements per second may be performed by the rotating instrument head. The resolution of the caliper measurements are determined by the line speed. For example, at 75 feet per minute each ½ inch square of wall area may be logged. At 37.5 feet per minute line speed, each ¼ inch square of wall area may be logged. Further, even the 120 wall thickness measurements made along each six inch length of pipe will be quite detailed. Sampling frequency and rotational speed may be precisely controlled to step the sampled points around the diameter of the well casing for each rotation. This allows 100% coverage for detailed anomaly logging. The data fiom the measurements may be digitized and compressed for transmission along the wireline to the surface.

In the detailed description following, structures bearing the same reference numbers throughout the various figures are the same structures as in the figure where they first appear. Further, the figures illustrate one embodiment employing the principles of the invention, but are not to be construed as limiting the invention to the single embodiment shown and described. Persons skilled in the art will recognize variations in structure that nevertheless do not depart from the concepts illustrated and described herein and set forth in the claims appended to this description.

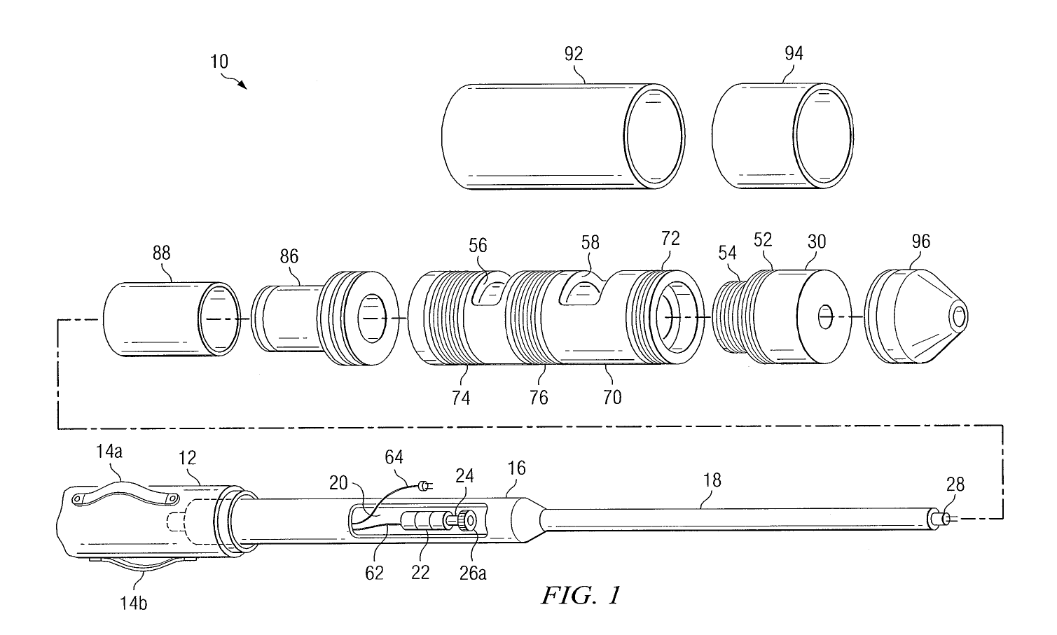

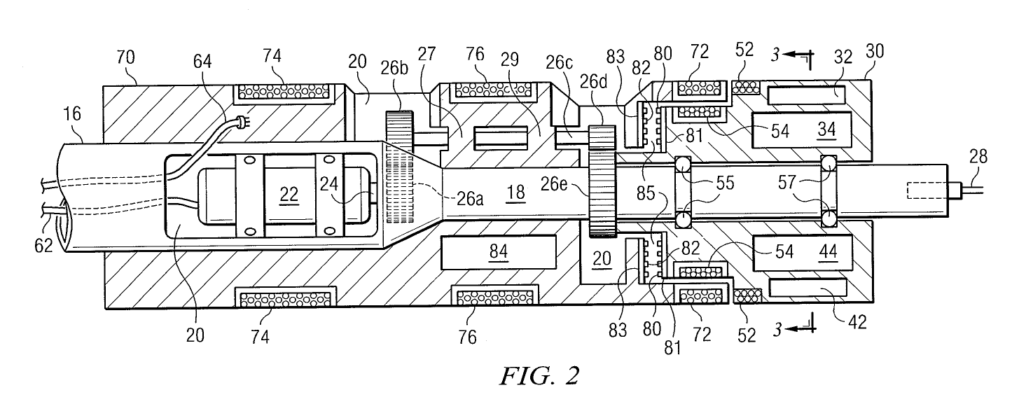

FIG. 1 illustrates an exploded view of the principle components of an instrument assembly portion of a casing inspection tool according to an embodiment of the present invention. In the lower row of components the instrument assembly 10 includes an instrument body 12, partially shown in FIG. 1, and two of the three centralizer springs 14a, 14b attached thereto, for centering the tool within a well casing or other pipe to be inspected using the tool. Shown emerging from the instrument body 12 is a main shaft 16. Main shaft 16 includes a smaller diameter extension shaft 18 thereof and a hollow motor cavity 20 within the main shaft 16. The motor cavity 20 is contiguous with an open space within the mandrel 70 that includes space for a gear train 26. The extension shaft 18 may have an axial bore therethrough to permit the routing of signal and/or power conductors. Motor 22 is preferably a DC brushless motor having an axial output shaft 24 to which is attached a drive gear 26a. As will be described herein below, drive gear 26a is a part of the gear train 26 shown in FIG. 2. Also shown in FIG. 1 is a motor lead 62 and an instrument lead 64 for supplying signals and/or power respectively to the motor 22 and the instrument assembly 10. The components of the instrument assembly 10 are generally aligned along the longitudinal axis of the main shaft 16 and its extension 18, as indicated by the broken line in the figure.

Continuing with FIG. 1, shown in the middle row of components are a rotating sensor head 30 and a mandrel 70, along with several associated components. The rotating instrument head 30 includes an average caliper coil 52 and a power coil 54 wound thereon, to be described herein below. The rotating sensor head 30, which may also be called a rotating instrument head 30, a rotating coil assembly 30, or simply sensor head 30 herein, is supported so that it rotates on bearings 55, 57 installed on the extension shaft 18, as shown in FIG. 2. The mandrel 70 is a hollow cylinder form that has three coils wound thereon and has first 56 and second 58 window openings through the wall of the mandrel 70 at two locations. The window openings 56, 58 provide clearance and access for portions of the gear train 26, as will be described. A caliper exciter coil 72 is disposed around the body of the mandrel 70 as shown. A 60 Hz exciter coil 74 is also disposed around the body of the mandrel 70. Positioned approximately half-way between the caliper exciter coil 72 and the exciter coil 74 is a permeability receiver coil 76, for measuring permeability of the casing to use as a correction factor in the wall thickness measurements.

The mandrel 70 is installed over the main shaft 16 so that it encloses the portion of the main shaft 16 containing the motor 22. The mandrel 70 is stationary with respect to the main shaft 16 in this embodiment. An oil volume compressor 86 and its associated sliding sleeve 88 are also assembled onto the main shaft 16 in the position next to the mandrel 70 as shown. The mandrel 70 and the rotating sensor head 30 are likewise enclosed within respective sleeves 92 and 94. An end cap 96 encloses the end of the rotating sensor head 30 and extension shaft 18. An opening in the end of the end cap 96 is provided for a wireline circuit connector 28.

The material used for fabricating the main shaft 16, the extension shaft 18, the oil volume compressor 86, sliding sleeve 88, sleeve 92, and cap 96 is stainless steel. The body of the rotating sensor head 30 and the mandrel 70 may preferably be fabricated of 30% glass filled PEEK™. PEEK™ is an acronym for polyetheretherketone, supplied by Victrex plc, of Lancashire, United Kingdom, www.victrex.com. PEEK™ is a thermoplastic material useable up to 600° F., and is highly resistant to abrasion and chemical substances within a relatively wide range of pH. As is well known, the glass fill provides reinforcement of the body of the mandrel 70. For the sleeve 94, which covers the rotating sensor head 30, a ceramic material such as type “Dura Z 18970 TTZ,” available from CoorsTek, Inc., Golden, Colo. 80403, www.coorstek.com, is recommended because of its transparency to electromagnetic signals and its mechanical and chemical properties. The exemplary instrument assembly 10, including the sleeves 92,94, has an overall diameter of approximately 4.25 inches and is configured for measurements in well casings having a diameter of 4.5 to 6.0 inches in diameter. Other embodiments of the casing inspection tool maybe configured for use in casings and pipes of up to 24 inches in diameter.

FIG. 2 illustrates a conceptual cross section view of an assembled casing inspection tool according to one embodiment of the present invention. The main shaft 16 and the extension shaft 18 are shown, upon which the mandrel 70 and the rotating sensor head 30 are installed. The components of the instrument assembly 10 are secured together with fasteners (not shown to reduce clutter in the drawings) such as set screws, snap rings, and lock nuts as appropriate. The interior of the instrument assembly 10 within the sleeves 92, 94 and cap 96 is filled with oil and joints sealed with O-rings and the like. The oil may be a low-viscosity silicon oil capable of withstanding very high pressures and temperatures in the down-hole environment of oil and gas drilling applications. The oil-filled spaces include the motor cavity 20 and the adjacent spaces occupied by the gear train 26. The sensor head 30 rotates freely on bearings 55, 57 set into respective bearing races in the extension shaft 18. As shown in this view the bearings 55, 57 may be of the ball bearing type. The sensor head 30 is driven, or caused to rotate, by a motor 22 driving through a gear train 26 that couples an output shaft 24 of motor 22 to the rotating sensor head 30. The gear train 26 includes a drive gear 26a and a driven gear 26e installed on a reduced diameter portion of the sensor head 30. Disposed to one side within the mandrel 70 along an axis parallel to the longitudinal axis of the main shaft 16 and the extension shaft 18, is a countershaft 26c (countershaft 26c may also be called a jack shaft 26c). Countershaft 26c includes a first gear 26b on an input end of countershaft 26c and a second gear 26d on an output end of countershaft 26c. The countershaft 26c may be preferably supported in ball bearings or bushings not shown in FIG. 2 but disposed in the body of the mandrel 70 at the bearing locations 27 and 29.

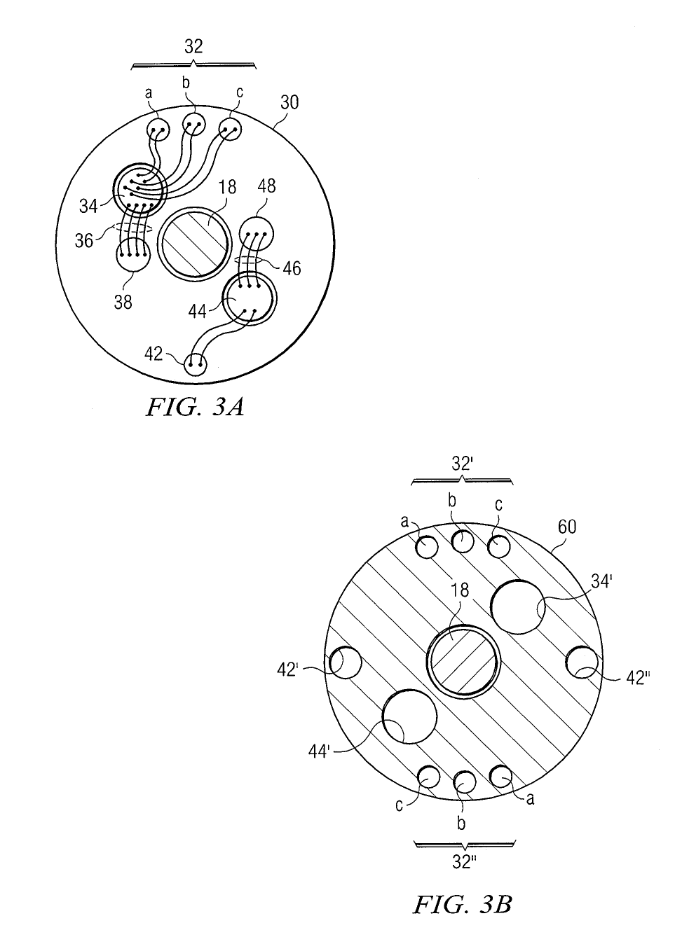

The gear train 26 shown in FIG. 2 functions as a step down, direct drive transmission that converts the RPM (revolutions per minute) of the motor 22 to the RPM required for the sensor head 30. In the illustrated embodiment, for example, the motor 22 spins at 10,000 RPM and the rotating sensor head 30 spins at 937.5 RPM in an embodiment of the tool that utilizes a dual set of detailed caliper coils 32′ as will be described in conjunction with FIG. 3B. One set of gear ratios necessary to provide this reduction of 10,000÷937.5=10.66 or, a ratio of 32 to 3. Such a ratio may be provided for example by an input gear ratio of 4 to 1 (provided by drive gear 26a and first gear 26b) and an output gear ratio of 8 to 3 (provided by second gear 26d and the driven gear 26e). Other examples are possible; the one chosen maybe determined by space requirements within the mandrel, availability of standard gear sets, and the like. Other considerations include the speed with which the instrument assembly 10 traverses the well casing and the rotational speed needed to produce the required resolution of the caliper and wall thickness measurements. As one alternate example, if the rotational speed of the rotating sensor head 30 is increased to 1875 RPM, by reducing the overall gear ratio by a factor of two to 16 to 3, only a single set of detailed caliper coils 32 is required to obtain the desired resolution of the measurements. This alternative will be further discussed as FIG. 3A is described herein below. Materials suggested for the gear train 26 include, for example, brass for the gears 26a, 26b, 26d, and 26e, and stainless steel for the countershaft 26c.

Continuing with FIG. 2, the sensor head 30 contains a number of electromagnetic coils that spin with the rotating sensor head 30 including a detailed caliper coil set 32, a detailed wall thickness coil 42, an average caliper coil 52, and a power coil 54. All of these coils except the wall thickness coil are configured to respond to 20 KHz signals produced by the exciter coils to be described. The wall thickness coil operates with a 60 Hz excitation signal. Circuitry associated with the caliper 32 and wall thickness 42 coils may be contained within respective pressure capsules 34 and 44 installed in corresponding bores within the body of the sensor head 30 as shown.

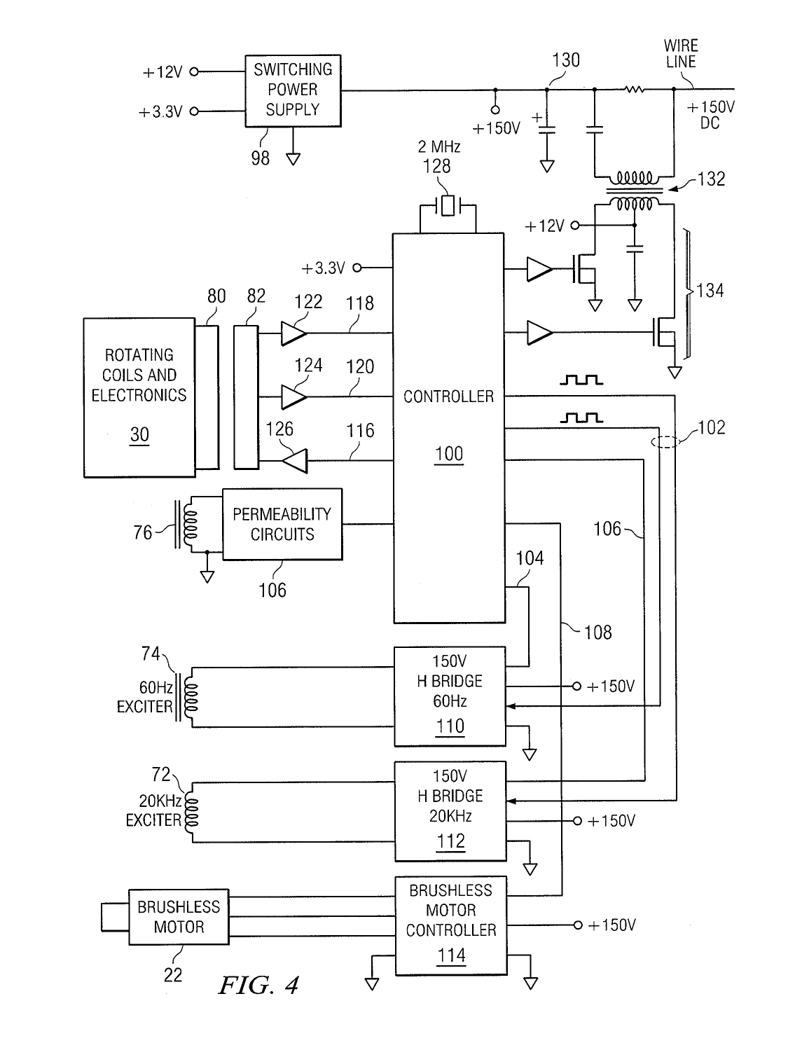

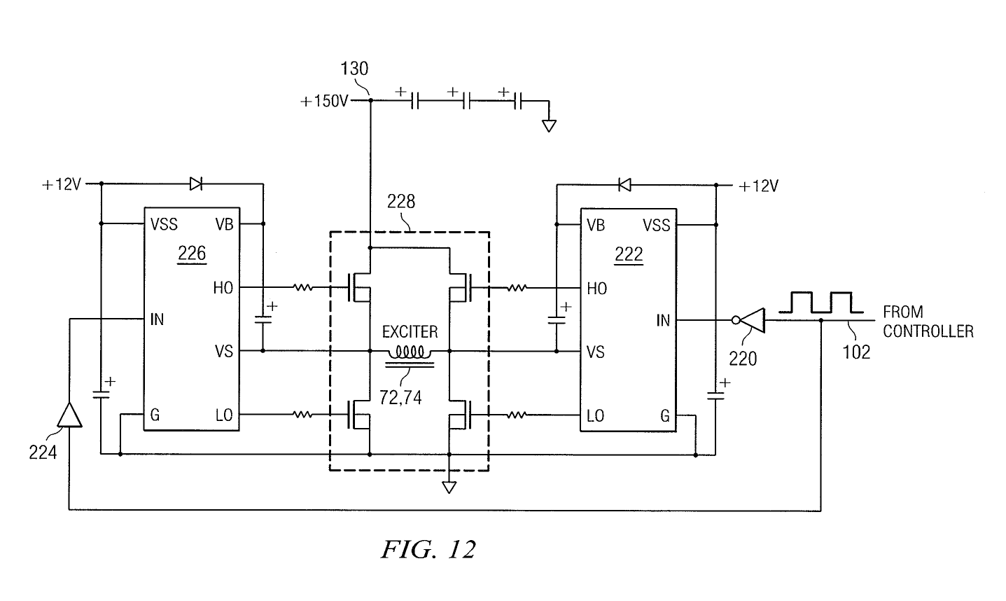

The mandrel 70 shown in FIG. 2 also supports several electromagnetic coils, which provide the excitation signals necessary for the sensor coils 32, 42, and 52 to produce measurement data of casing caliper and wall thickness. A caliper exciter coil 72 is disposed around the body of the mandrel 70 as shown, in the region where the mandrel 70 body surrounds a portion of the sensor head 30. The caliper exciter coil in this example provides a 20 KHz waveform to be described. A 60 Hz exciter coil 74 is disposed around the body of the mandrel 70 approximately 12 to 13 inches above (i.e., toward the upper end of the tool and to the left in the figure) caliper exciter coil 72. Positioned approximately half-way between the caliper coil 72 and the exciter coil 74 is a permeability receiver coil 76, which receives information embodied in second harmonic of the signal from the 60 Hz exciter coil 74, to be described for FIGS. 4 and 12, for measuring the permeability of the casing to use as a correction factor in the wall thickness measurements.

Electronic circuits associated with the coils disposed on the mandrel 70 may be located in a space provided in the body of the mandrel 70 approximately in the vicinity of the permeability receiver coil 76, and opposite the countershaft 26c of the gear train 26. Circuit connections between the mandrel 70 and the rotating sensor head 30 are provided by sets of capacitive slip rings 80, 82 located on adjacent faces of the rotating sensor head 30 and the mandrel 70. The capacitive slip rings 80, 82 permit the transfer of AC signals across a gap between one (rotating) plate of a capacitor and an adjacent (non-rotating) plate of the capacitor.

In one embodiment, the respective plates of the capacitor may be implemented as a set of concentric rings on first and second circular printed circuit (PC) boards that are centered on the same axis. See FIGS. 2 and 4, which illustrate, in edge-wise view, a rotating PC board 81 and a non-rotating PC board 83, facing each other across a gap 85 disposed between the sensor head 30 and the mandrel 70. The gap, in this example, may be approximately 0.030 inch or 0.75 mm, and the dielectric material in the gap maybe the low-viscosity oil that fills the mandrel 70. The approximate dielectric constant of such oil is nominally 2.0. Each pair of concentric rings, in facing juxtaposition across the gap acts as a capacitor, with one plate (a conductive ring on the first PC board) spinning and the other plate (corresponding conductive ring on the second PC board) not spinning. Each pair of plates thus acts as the terminals of a connector that is able to couple AC signals from one circuit to another. Each plate is connected to a respective node or line in a circuit that outputs or inputs a signal coupled through the capacitive slip ring (80, 82) “connector.” In general, the area of each of the concentric rings is equal, and capacitances in the range of 1.0 to 100 picoFarads are feasible with this construction. In the exemplary embodiment, capacitance values of 5 to 50 picoFarads are suitable for providing the needed AC coupling. One example of a capacitive slip ring assembly 80, 82 is illustrated and further described in FIG. 14.

In the present application, the capacitive slip rings 80, 82 permit the exchange of information and signals across the gap between the stationary mandrel 70 and the rotating sensor head 30. Power is provided to the circuits in the rotating sensor head by 20 KHz energy coupled into the power coil 54 from the caliper exciter coil 72 and rectified in the sensor head, as will be described for FIG. 13 to be described. Several leads shown in FIG. 2 provide current via lead 62 for operation of the motor 22, signal conductors in a cable 64 for signals to/from the electronics circuitry associated with the excitation and the measurements made by the caliper and wall thickness sensors, and the supply of electrical power to the circuitry in the instrument assembly 10. A wireline and its associated connector 28 may be provided as needed for other instrumentation.

FIG. 3A illustrates a lateral cross section view of a rotating portion of the embodiment of FIGS. 1 and 2, taken at the cross section denoted by the arrows marked 3-3 in FIG. 2, FIG. 3A illustrates a configuration of the caliper 32 and wall thickness 42 coil assemblies in an embodiment wherein the rotational speed of the rotating sensor head 30 is approximately 1875 RPM. An alternate embodiment for use with tools wherein the rotational speed is reduced to 937 RPM is shown in FIG. 3B, which may employ two sets of caliper and wall thickness coil assemblies.

In FIG. 3A the sensor head 30, which spins on bearings 55, 57 about the extension shaft 18, includes a detailed caliper coil assembly of three separate coils, 32a, 32b, and 32c. Coils 32a and 32c are called focus coils. Coil 32b is called a main coil. Each of the three caliper coils 32a, b, and c is connected through a set of conductors to the detailed caliper electronics circuits 34, which are enclosed in a pressure capsule within the body of the sensor head 30. Connecting leads 36 connect the circuits 34 to the main body of the tool via the capacitive slip rings 80, 82. Similarly, the wall thickness coil assembly 42 is connected through a set of conductors to the detailed wall thickness circuits 44, which are likewise enclosed in a pressure capsule at the location 44. Connecting leads 46 connect the circuits 44 to the main body of the tool via the slip rings 80, 82.

In FIG. 3B the sensor head 60, which spins on bearings 55, 57 about the extension shaft 18, includes dual detailed caliper coil assemblies of three separate coils each, 32′a, b, and c, and 32″a, b, and c. Coils 32′a and 32′c are called focus coils, as are coils 32″a and c. Coils 32′b and 32″b are called main coils. Each set of three caliper coils 32′ and 32″ is connected through a set of conductors (not shown, but are as illustrated in FIG. 3A) to the detailed caliper electronics circuits 34′, which are enclosed in pressure capsules. Similarly, Connecting leads (not shown) may also connect the circuits 34′ and 44′ to the main body of the tool via the capacitive slip rings 80, 82. Similarly, the wall thickness coil assembly 42′ may be connected through a set of conductors to the detailed wall thickness circuits 44″, which are enclosed in a pressure capsule.

The coils illustrated in the embodiment shown in FIGS. 2, 3A, and 3B may be constructed as follows:

Detailed caliper coil 32: The three coils 32a, 32b, and 32c are all wound the same, as bobbin coils of 1,000 turns of 40 AWG wire, on cores of standard transformer laminations having a permeability of approximately 5000.

Detailed wall thickness coil 42: This coil is also wound as a bobbin coil of 10,000 turns of 40 AWG wire, on cores of standard transformer laminations.

Average caliper coil 52: An air wound coil, around the rotating head 30, of 700 turns of 40 AWG wire.

Power coil 54: An air wound coil, around the rotating head 30, of 70 turns of 28 AWG wire. Note that the clearance between the outside diameter of the power coil 54 and the inside diameter of the caliper exciter coil is preferred as 1/16 inch, of which one-half or approximately 0.030 inch is the thickness of the body of the mandrel 70 upon which the caliper exciter coil is wound

Caliper (20 KHz) exciter coil 72: An air wound coil, around the mandrel 70, of 700 turns of 28 AWG wire.

60 Hz Exciter coil 74: Wound on a high permeability, laminated stack core (approx. 0.125 inch stack), of 1000 turns of 28 AWG wire.

120 Hz Permeability receiver coil 76: Wound on a laminated, high permeability, laminated stack core (approx. 0.125 inch stack), of 1000 to 2000 turns of 40 AWG wire.

FIG. 4 illustrates a simplified circuit diagram of circuits in the embodiment of FIGS. 1, 2, and 3A and 3B. Some of the structures shown in FIG. 4 have already been described, such as the rotating coils and electronics 30 (i.e., the rotating sensor head 30) and the slip rings 80, 82, the caliper exciter coil 72, the 60 Hz exciter coil 74, the permeability receiver coil 76, and the brushless motor 22. A principal component of the non-rotating circuitry shown in FIG. 4 is the controller 100, which executes instructions for the operation and control of the circuits in the well casing inspection tool 10. This processing includes the generation of drive signals for the exciter coils 72, 74 and the brushless motor 22. The controller also controls and processes signals picked up from the rotating sensor head electronics via the capacitive slip rings 80, 82. A suitable component for controller 100 is a standard field programmable gate array (FPGA) logic chip (integrated circuit), type XCRxxxx-10TQ144I manufactured by Xilinx, Inc., San Jose, Calif., www.xilinx.com. Shown connected to the controller 100 is a 2 MHz crystal 128 that serves as a reference for the internal oscillator of the controller, from which various clock signals are derived for the operation of the processing circuits.

Continuing with FIG. 4, controller 100 in this example outputs 3.3 Volt square wave reference signals at 60 Hz and 20 KHz that may be coupled via lines 102 to respective inputs of the 60 Hz and 20 KHz exciter circuits, 110 and 112. Controller 100 also outputs a 60 Hz drive signal via line 104 to an input of the 60 Hz exciter circuit 110, a 20 KHz drive signal via line 106 to an input of the 20 KHz exciter circuit 112, and a DC motor drive signal via line 108 to an input of motor controller 114. All three of the circuits 110, 112, and 114 receive +150 Volt supply from a +150 Volt DC buss 130 coupled to the wireline. For the controller 100 and other low voltage circuits, a switching power supply 98 provides +12 Volt and +3.3 Volt outputs for use by the circuits in the non-rotating mandrel 70. One use of the +12 Volt supply is to the centertap of coupling transformer 132. Coupling transformer 132 couples the output interface driver circuit 134 from the controller 100 to the wireline for transmitting data to the surface. Signals processed by the controller 100 include control signals coupled via line 116, which may include a buffer amplifier 126, and the capacitive slip rings 82, 80 to the rotating sensor head 30. Similarly, signals from the rotating sensor head 30 are coupled via the capacitive split rings 80, 82 and lines 118 and 120 to inputs of the controller 100 for processing. The lines 118 and 120 may include buffer amplifiers 122 and 124 as shown.

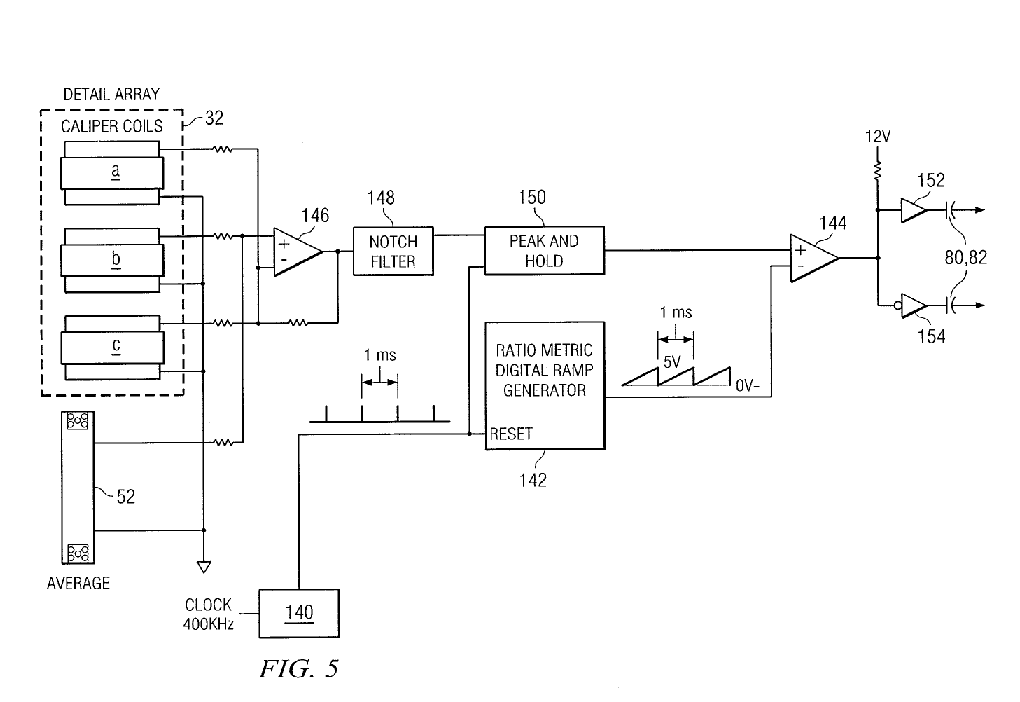

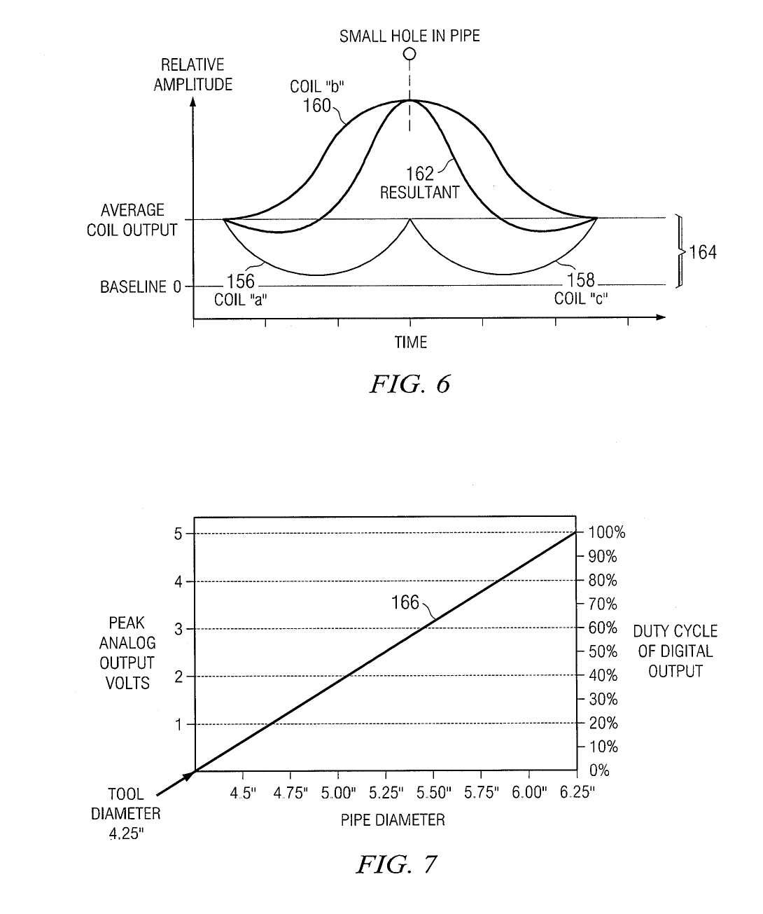

The operation of the caliper measurements will be described with the aid of FIGS. 5, 6, and 7. Beginning with FIG. 5, there is illustrated a simplified circuit diagram of the caliper sensor circuits of FIG. 3 that are disposed in the rotating portion of the casing inspection tool 10 of FIGS. 1 and 2. The detail caliper array 32 is shown within a dashed line outline enclosing the three caliper coils, 32a, 32b, and 32c. Coils 32a and 32c are called the “focus” coils and 32b is called the “main” caliper coil. The functions of these coils will become clear in the description of FIG. 6 to follow. Also shown is the “average” caliper coil 52 and the “output” slip rings 80, which are the conductive “plates” (of the capacitive slip rings 80, 82) on the sensor head 30 side of the gap between the rotating sensor head 30 and the non-rotating mandrel 70. As described, the mandrel 70 contains the controller 100 for processing the caliper signals coupled thereto via the capacitive slip rings 80, 82 as shown in FIG. 4.

Continuing with FIG. 5, a clock divider 140 provides a 1.0 KHz pulse waveform for triggering a ratiometric digital ramp generator 142, which outputs a 1.0 KHz sawtooth waveform having an amplitude range of zero (0) to five Volts. The clock divider 140 and ramp generator 142 may be implemented within the FPGA controller 100. The sawtooth waveform, which may be produced by a capacitor charge pump circuit in the ramp generator 142, for example, is fed to the negative input of comparator 144 for gating sensed caliper data to the capacitive slip rings 80. Amplifiers 152, 154 serve to buffer the loading of the capacitive slip rings 80 from the sensing circuits. The sensing circuits for the caliper signals include amplifier 146, followed by a 60 Hz notch filter 148 and a peak and hold circuit 150.

The amplifier 146 sums the outputs of the focus coils and compares them with the signal(s) provided from the main caliper coil 32b to provide detailed measurements of the casing diameter for resolving anomalies—any deviation in the diameter of the well casing from its nominal uniform diameter. The average caliper coil 52 provides a baseline measurement of the diameter of the well casing by measuring the amount by which the casing internal diameter exceeds the outside diameter of the casing inspection tool 10. Thus, the voltage output of the average caliper coil 52 is zero Volts when the casing diameter=the tool diameter, and the voltage is +5 Volts when the casing diameter exceeds the tool diameter by 1.0 inch. This 5 Volts per inch relationship is converted to a duty cycle variation of zero to nearly 100%. The caliper coil array 32 (focus and main caliper coils 32a, b, c) thus acts to provide the detail measurement data, as in a vernier measurement. For example, in well casing pipe having a uniformly constant internal diameter, with no variations or anomalies, the analog outputs of the main 32b and focus 32a, 32c coils will add to zero so that the only output from the caliper circuit is equal to the average caliper coil output. Thus, the complete caliper measurement is provided by the sum of the outputs of the average caliper coil 52 and the detailed caliper array coils 32. This relationship will be further described with FIG. 6.

Continuing with FIG. 5, the 60 Hz notch filter 148 removes any residual 60 Hz component that the caliper coils may pick up from the 60 Hz exciter coil 74. The output of the notch filter 148 is processed by a peak and hold circuit 150 that is driven by the 1.0 KHz pulse to sample the caliper coil output in comparator 144 and preserve the caliper data as phase information. Comparator 144 provides a 1.0 KHz square wave whose duty cycle varies with the phase information in proportion to the internal diameter of the well casing. The duty cycle increases accordingly as the amplitude of the caliper coil output increases, which in turn varies as the internal diameter of the well casing increases. As will be described further with FIG. 7, the transfer function at the output of comparator 144 in this example is approximately 0.4 inch/Volt, where 1.0 Volt=20% duty cycle for the square wave output, and 5.0 Volts=100% duty cycle. Thus, the duty cycle of the output of the circuit of FIG. 5 is a direct measurement of the radii of the well casing at each particular point as the rotating sensor head 30 spins within the well casing. The square wave duty cycle waveform coupled through the capacitive slip rings 80, 82 is converted to digital numbers and stored in memory in the controller 100 until transmitted to the surface via the wireline through the coupling circuit shown in FIG. 4.

FIG. 6 illustrates coil response waveforms of the caliper sensor circuits of FIGS. 3 and 5, plotted together on a single graph to show individual and resultant waveforms that are input to the circuit shown in FIG. 5. The graph plots relative amplitude on the vertical axis vs. time on the horizontal axis. The curves represent signal currents flowing in the caliper coil windings 32a, b, and c that are induced from the 20 KHz caliper exciter coil 72. In the example illustrated, a small hole in the well casing, placed at one angular location along the casing wall, is indicated on the graph as a reference for examining the effects on the caliper signals of a simulated anomaly in the well casing.

In the graph shown in FIG. 6, the output of detailed caliper “focus” coil 32a is represented by the curve 156. Similarly, the output of detailed caliper “focus” coil 32c is represented by the curve 158. Further, the output of the detailed caliper “main” coil 32b is represented by the curve 160. When these three detailed coil outputs are summed in the amplifier 146 (FIG. 5), the resultant curve is shown as the resultant 162. In this example, the curve 162 indicates that the detailed caliper coils 32 detected a small hole in the wall of the well casing The indication is provided by the variation in the caliper or internal diameter of the casing. The resultant curve 162 includes a peak relative amplitude just below the symbol on the graph for a small hole in the casing wall. Thus, in general, any anomaly in the casing diameter will appear as a resultant curve graphically shows the extent and type of anomaly. The graph includes a relative baseline 0 to indicate when the output of the average coil 52 is zero (0). The graph also indicates a relative baseline “average coil output” of a non-zero value (here, it is shown above the relative baseline 0) that indicates that the internal diameter of the well casing or pipe is greater than the outside diameter of the casing inspection tool 10.

As explained with FIG. 5, the amplifier 146 sums the outputs of the focus coils and compares them with the signal(s) provided from the main caliper from coil 32b. Any output thus provided is added to the output of the average caliper coil 52. For example, in well casing having a uniformly constant internal diameter, near the outer diameter of the tool, the analog outputs of the main 32b and focus 32a, 32c coils will add to zero. Thus the resultant output that may be plotted on the graph of FIG. 6 will be a flat line at the relative amplitude line=some constant value near zero on the vertical axis. However, if there is a substantial non-zero output from the average caliper coil 52, the effect is to raise the baseline relative amplitude on the graph of FIG. 6 above the zero level, as indicated on the graph by the reference number 164. The sum of the outputs of the average caliper coil 52 and the detailed caliper array 32 provides the complete measurement of the internal diameter of the well casing. If the net output of the detailed coil array is zero, then there are no anomalies and the well casing or pipe diameter is uniform, as indicated by the average caliper coil 52 output.

Referring to FIG. 7, there is illustrated the relationship of the analog and digital signals of the caliper sensor circuits of FIG. 5. This caliper transfer function 166 is plotted on a graph of peak analog Volts along the left-hand vertical axis vs. pipe diameter in inches along the horizontal axis. The duty cycle corresponding to the peak analog Volts is indicated along the right-hand vertical axis. It is apparent that there is a straight line relationship between the duty cycle and the pipe diameter. In this example, a duty cycle of 50% corresponds to a pipe diameter of approximately 5.25 inches and an analog caliper output voltage of approximately 2.5 Volts.

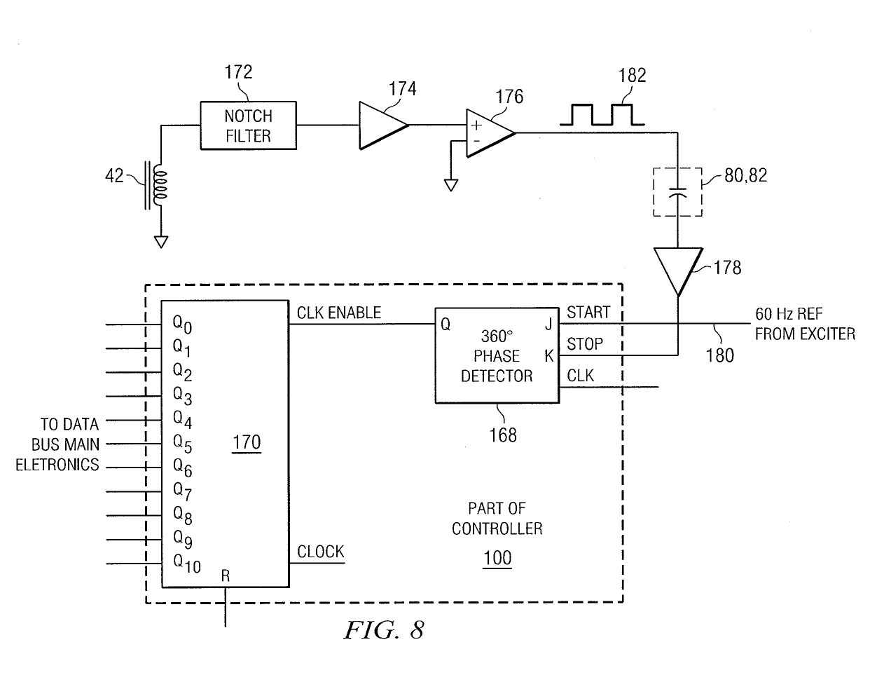

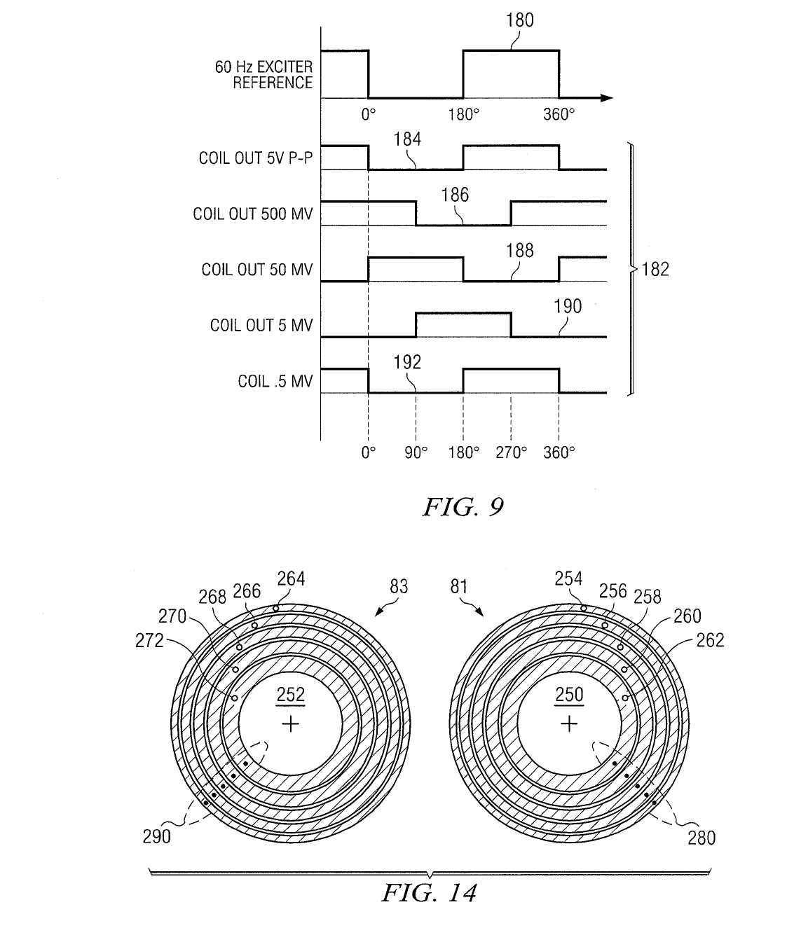

Referring to FIG. 8, there is illustrated a simplified circuit diagram of wall thickness circuits of the rotating portion of the embodiment of FIG. 3 that are disposed in the rotating portion of the casing inspection tool 10 of FIGS. 1 and 2. It will be recognized that the circuit of FIG. 8 is similar in topology to the circuit for the caliper measurement circuit shown in FIG. 5. The detailed wall thickness coil 42, located in the rotating sensor head 30 at the position shown in FIG. 3A (or, in an alternate embodiment shown in FIG. 3B), is responsive to the flux induced into the well casing pipe by the 60 Hz exciter coil 74 shown in FIGS. 1, 2, and 4. Because of the physical arrangement of the coils 74, 42 the flux path re-enters the casing inspection tool 10 at the location of the detailed wall thickness coil 42 in the rotating sensor head 30. The phase shift between the exciter voltage (a 300 Volt peak-to-peak, 60 Hz signal) and the detailed wall thickness coil voltage is directly proportional to the depth into the metal of the well casing that is penetrated by the magnetic flux. Thus, the thickness information is encoded in the phase of the output signal from the detailed wall thickness coil relative to the reference 60 Hz signal 180 from the exciter circuit (See FIG. 12). The transfer relationship in the example illustrated may be approximately one degree of phase shift per 1/1000 inch of wall thickness (e.g., 1 deg./mil.), including the “entering” thickness plus the “exiting” thickness. An illustration of this relationship is presented in FIG. 9.

Continuing with FIG. 8, the detailed wall thickness coil 42 picks up both the 60 Hz exciter signal and the 20 KHz caliper exciter signal. Notch filter 172 removes the 20 KHz component, and the following amplifier 174 boosts the signal level approximately 1000 times. Comparator 176 forms a symmetrical 60 Hz square wave signal 182 (which may have a peak-to-peak amplitude of 12 Volts in this example), which is coupled via the capacitive slip rings 80, 82 and a buffer amplifier 178 to an input of a J-K flip flop 168, which is configured as a 360 degree phase detector in shown in simplified form in this example. The phase detector 168 and the following 10 stage binary counter 170 may be part of the FPGA controller 100 as shown within the dashed line outline. The binary counter 170 outputs a count value in the range zero to 1028, which corresponds to a wall thickness range of zero to 1.028 inches. In operation the output of the binary counter 170, triggered by the Q output of the (J-K flip flop) phase detector 168, counts until the rising waveform of the wall thickness output causes the output level at the Q output to fall at the phase shift value encoded in the phase detector output. At that point, the numerical value in the counter 170 is equal to the wall thickness over (at the location of) the detailed wall thickness coil 42 and the average wall thickness over (at the location of) the exciter 74. This value is coupled to the main data bus in the controller 100 to provide a digitized representation of the wall thickness for storage and later transmission to the surface along the wireline (see FIG. 4. The counter 170 is then reset. A wall thickness measurement thus made occurs at each transition of the 60 Hz square wave, or 120 times per second.

Referring to FIG. 9, there is illustrated a family of curves of the response characteristic of the detailed wall thickness circuit of FIG. 8, shown in relation to the 60 Hz reference signal 180 from the exciter, shown at the top of the graph. The 60 Hz reference appears as a full cycle of a square wave with a falling transition at zero (0) degrees, a rising transition at 180 degrees, and a repeat of the falling transition at 360 degrees. Each of the wall thickness coil outputs 182 shown correspond to a phase shift of ninety (90) degrees and a signal amplitude that occurs at 90 degree intervals, according to the transfer function of the wall thickness measurement circuit of FIG. 8. Thus, at zero degrees, the peak value is 5 Volts (signal 184); at 90 degrees, the peak value is 0.5 Volt (signal 186) or 500 millivolts (mV); at 180 degrees, the peak value is 50 mV (signal 188); at 270 degrees, the peak value is 5.0 mV (signal 190); and at 360 degrees, the peak value is 0.5 mV (signal 192). In this way, the phase of the trailing edge of the output voltage signal is a measure of the wall thickness of the well casing. In other words, the wall thickness measurement is manifest as a phase shift of the wall thickness coil output relative to the 60 Hz exciter signal.

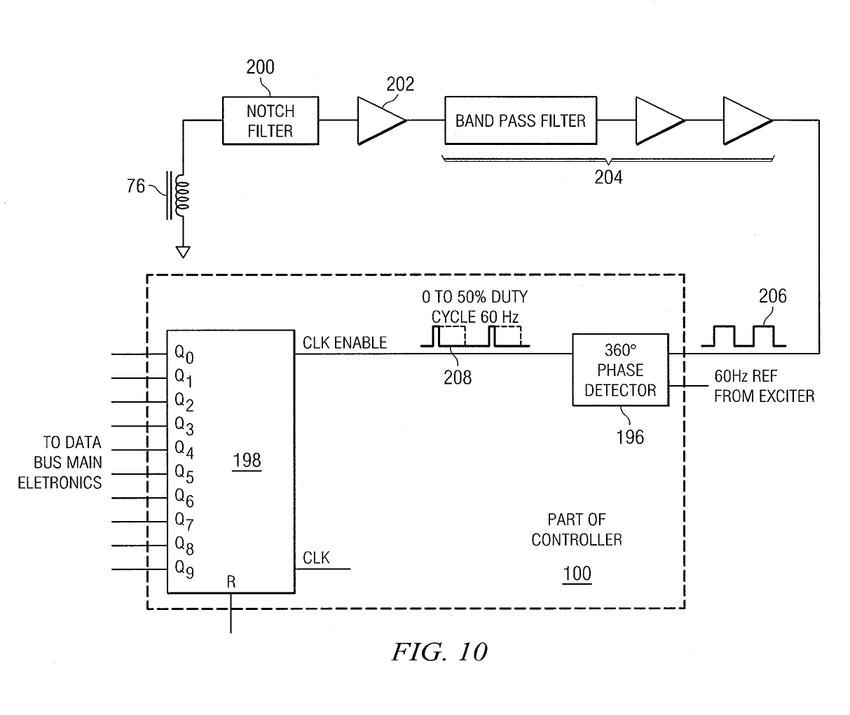

Referring to FIG. 10, there is illustrated a simplified schematic diagram of a permeability measurement circuit of the embodiment of FIGS. 1 and 2. The permeability measurement circuit is implemented as a phase detector circuit that is similar to the circuit of FIG. 8 and also shown in FIG. 10 in simplified form. In the exemplary embodiment, the 60 Hz exciter coil 74 and the 120 Hz permeability coil 76 are positioned relatively close together—6.0 inches apart in this example—along the outer surface of the body of the mandrel 70. The permeability coil 76 thus functions as a receiver coil for the magnetic flux established in the well casing by the exciter coil. In reaching the permeability coil 76, the flux traverses the wall of the well casing or pipe once as it enters the casing and once again as it exits the casing wall. Each traverse is accompanied by a phase change of one radian. This phase shift is dependent on the permeability of the casing material according to the following relationship:

Φ=2πd(fμ÷c10³)½

where Φ is the phase shift in radians, d is the casing wall thickness in centimeters, f is the excitation frequency in Hz, μ is the permeability of the casing material, and c is a conversion factor in centimeters.

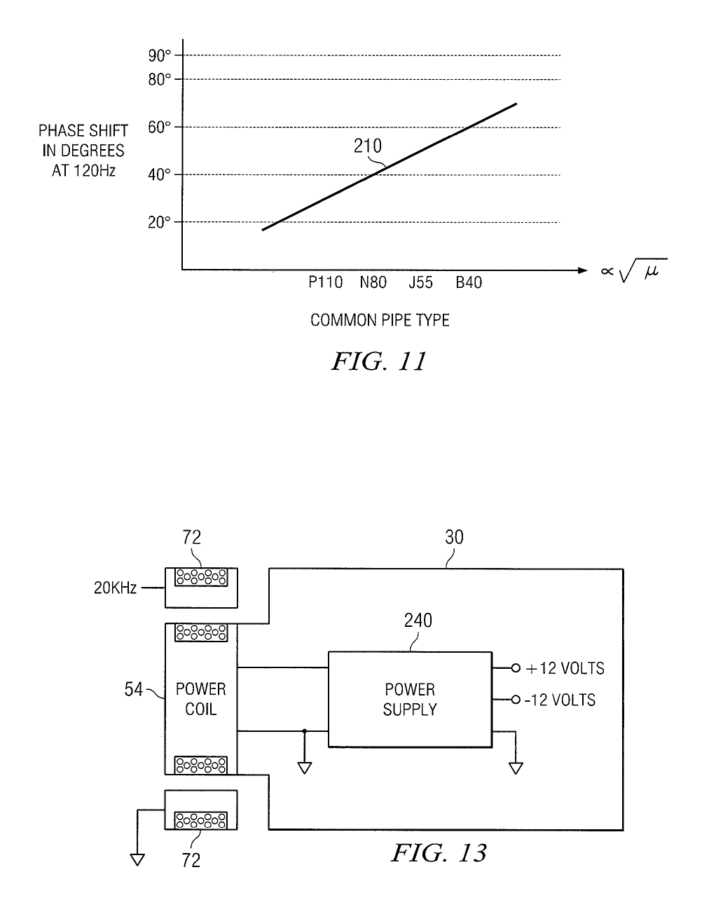

In general, the magnetic permeability of a casing material varies inversely with the strength of the material but elicits a proportional change in phase shift. To illustrate, the phase shift produced at the output of the permeability coil can range from approximately 30° for type “P110” material (having a relatively low permeability) to approximately 60° for type B40 material, which has a relatively higher permeability. Thus, the lower phase shift value corresponds to a low permeability and a higher phase shift corresponds to a higher permeability. These characteristics are illustrated in FIG. 11, where the vertical axis is marked in the phase shift in degrees at 120 Hz, and the horizontal axis represents a factor proportional to the square root of the magnetic permeability for several common types of well casing pipe. The relationship between the phase shift and the permeability factor is represented by the straight line 210 in the graph.

Continuing with FIG. 10, the signal supplied by the permeability coil 76 is passed through a notch filter circuit 200, an amplifier 202, and a bandpass filter circuit 204, which includes an amplifier having a gain of ten and a comparator to remove amplitude information from the signal. The notch filter 200 removes the 60 Hz component of the received signal, the bandpass filter 204 rejects frequencies above and below the band defined as 100 to 300 Hz, and the comparator removes remaining amplitude information in order to preserve the permeability information encoded in the phase of the 120 Hz signal. The resulting permeability signal, a square wave with varying duty cycle proportional to the phase shift of the magnetic flux, is applied to the 360° phase detector 196, which is triggered by a 60 Hz reference from the 60 Hz exciter 74 that is applied to the Start terminal of the simplified J-K flip flop used as a phase detector. The phase detector 196 outputs a pulse wave train having a pulse positioned at each transition of the 60 Hz reference, thus providing a phase detection signal at a 120 Hz rate, i.e., 120 readings per second. The pulses, which vary in duty cycle depending on the phase shift (e.g., from approximately 30° to 50°), are coupled to a clock enable input of a binary counter 198, which may be implemented in this example by portions of the FPGA controller 100. The binary counter 198 converts the waveform information to digital numbers and transmits them via the data bus to a memory location in the controller 100 for storage and further processing before transmitting the data to the surface.

Measuring wall thickness by measuring the phase shift between transmitted and received signals, and correcting the resulting thickness measurement using a phase shift signal that is a function of the permeability of the casing material are well known techniques. These techniques are described in U.S. Pat. No. 4,708,204, Stroud, and United Kingdom Patent No. GB 2 037 439, Smith, both incorporated herein by reference. In brief, since both phase shift measurements are proportional to the square root of the permeability, the correction to the wall thickness measurement is made by dividing the phase shift due to the wall thickness by the phase shift due to the permeability to arrive at the corrected wall thickness measurement. Thus,

d=(Φ_{I}÷Φ_{P})k,

where d is the wall thickness, Φ_{I} is the phase shift due to the wall thickness, Φ_{P} is the phase shift due to the permeability measurement, and k is a proportionality constant. What differentiates the present invention from the methods of the prior art is the incorporation of a smaller receiver coil for measuring wall thickness into the outermost portion of a spinning sensor head, which enables close proximity scanning of the full circumference of the casing at high resolution.

Referring to FIG. 12, there is illustrated a simplified circuit diagram of the topology of an exciter circuit for use in the embodiment of FIGS. 1, 2 and 3. The same exciter circuit may be used for both the 20 KHz caliper exciter 72 and the 60 Hz exciter 74, the only substantial difference being the frequency of the input reference waveform 102 generated in the controller 100. The reference waveform 102 may be a 3.3 Volt square wave divided down from the reference clock operating at 2.0 MHz. The controller generates a 20 KHz version for use by the 20 KHz exciter 72 and a 60 Hz version for use by the 60 Hz exciter 74. The circuit used for the exciters may be an “H” bridge topology formed by four high power FET (field effect transistor) devices such as type IRF640 connected in a bridge circuit 228. The exciter coil 72, 74 is connected across the bridge output terminals as shown, and the input terminals are connected across the output of a power supply that supplies 150 Volts DC to the bridge 228. Each side of the bridge 228 is driven through an inverter by the output of a driver IC 222, 226, which in this example may be a type IR251115, and connected as shown in FIG. 12. The reference waveform 102 is coupled to an input of the driver circuits 222, 226 via an inverter circuit 220, 224 respectively. The driver circuits 222, 226 are powered by +12 Volts supplied from the power supply illustrated in FIG. 4. The high power FET devices and the driver IC devices in this example are available from International Rectifier Corp., El Segundo, Calif. 90245.

Referring to FIG. 13, there is illustrated a simplified circuit diagram of a power coupling circuit for use in the rotating sensor head 30 of the embodiment of FIGS. 1, 2 and 3. The sensor head 30 is shown in simplified cross section and containing a power supply circuit 240. The power supply 240 receives AC current from a power coil 54 and generates ±12 Volts from this input. The input from the power coil 54 is induced therein by the closely coupled caliper exciter coil 72. Thus, the power circuit 240 operates with a 20 KHz AC input voltage to provide the low voltage DC outputs by switching power supply circuits well known in the art. The high frequency of the input AC voltage permits the use of small transformer windings, appropriate for use in the rotating sensor head 30.

FIG. 14 illustrates one embodiment of a capacitive slip ring (“CSR”) coupling device according to the present invention. In the illustrated embodiment, the respective plates of the capacitor may be implemented as a set of concentric conductive foil rings etched on first and second circular printed circuit (PC) boards 81, 83. The PC boards 81, 83 are centered on the same longitudinal axis of the main and extension shafts 16, 18 as the rotating sensor head 30 and the non-rotating mandrel 70 with the conductive rings facing each other across the gap 85. See the example shown in FIG. 2, which illustrates, in edge-wise view, a rotating PC board 81 and a non-rotating PC board 83, facing each other across the gap 85 disposed between the sensor head 30 and the mandrel 70. The gap 85, in this example, may be approximately 0.030 inch or 0.75 mm, and the dielectric material in the gap 85 may be the low-viscosity oil that fills the mandrel 70. The approximate dielectric constant of such oil is nominally 2.0 Each pair of concentric rings, in facing juxtaposition across the gap 85 acts as a capacitor, with one plate (a ring on the first PC board) spinning and the other plate (a corresponding ring on the second PC board) not spinning. Each pair of opposing plates thus acts as the terminals of a connector that is able to capacitively couple AC signals between respective circuits connected to concentric ring “plates” of the capacitive slip ring (80, 82) “connector.” In general, the area of each of the concentric rings is equal, and capacitances in the range of approximately 1.0 to 100 picoFarads (pF) are feasible with this construction. In the exemplary embodiment, capacitance values of 5 to 50 pF have proven suitable for providing the needed AC coupling.

Continuing with FIG. 14, illustrating the CSR PC boards, 81, 83, wherein each PC board 81, 83 includes an array of circular concentric conductive foil areas. For example, PC board 81 may include five such conductive concentric rings, respectively indicated by reference numbers 254, 256, 258, 260, and 262, reading from the outermost ring 254 toward the center of the rings indicated by reference number 250. Similarly, PC board 83 includes five such conductive concentric rings, respectively indicated by reference numbers 264, 266, 268, 270, and 272, reading from the outermost ring 264 toward the center of the rings indicated by reference number 252. When the PC boards 81, 83 are centered on the longitudinal axis of the extension shaft 18 of the instrument assembly 10 and placed in juxtaposition across the gap 85, each facing pair of conductive concentric rings 254/264, 256/266, 258/268, 260/270, and 262/272, in combination with a dielectric material disposed between them, forms a capacitor. The area of the two rings in each facing pair is the same. Moreover, typically, all of the rings will have the same area. However, in some applications it is possible that the capacitance will need to be varied by varying the area of the rings in a specific pair. The location of connections to each of the rings is indicated in the figure by the dots disposed within the foil area of each ring. In general, the connections to the rings may be made to the back side (reverse) because the facing side (obverse) must be clear of surface irregularities so that the gap 85 (not shown in FIG. 14) remains uniform at all points of the surface of the rings. The connections 280, 290 may be made by soldering connecting wires (not shown) or other secure method that ensures a durable electrical connection.

The capacitive slip ring (CSR) assembly 80, 82 disclosed herein and illustrated in FIGS. 2 and 14 is particularly effective in any application for coupling digital or pulse signals across the 85 gap between component assemblies which are rotating with respect to each other. An added advantage is that, in general, the amplitude of such digital signals as coupled to the “receiving” plate of the capacitor need only exceed the noise threshold in the system to fully convey the information embodied in the signal. The CSR assembly 80, 82 as described herein is a relatively low-noise device when constructed with smooth surfaces to minimize turbulence in the medium used as a dielectric. It is mechanically very rugged and may also be fabricated at very low cost. As is well known to persons skilled in the art, the circuit interfaces to each plate of a CSR capacitor depends on the nature of the circuit being connected. Thus, a “CSR” capacitor is treated like any other capacitor with regard to the AC signals being coupled there through.

While the invention has been shown in only one of its forms, it is not thus limited but is susceptible to various changes and modifications without departing from the spirit thereof.

What is claimed is:

1. A signal coupling apparatus, comprising:
first and second flat conductive rings disposed on respective first and second planar substrates, said rings centered on a common axis and disposed in a facing, spaced apart relationship across a defined gap, wherein said rings form respective plates of a capacitor for coupling electrical signals therebetween.

2. The apparatus of claim 1, wherein one of said first and second planar substrates is configured to rotate with respect to the other of said planar substrates.

3. The apparatus of claim 1, wherein each said first and second planar substrate comprises:
a plurality of said flat conductive rings arranged concentrically on each first and second substrate in corresponding pairs, thereby forming a plurality of such capacitors.

4. The apparatus of claim 3, wherein said flat conductive rings comprise:
conductive surfaces having substantially equal areas for each corresponding pair of rings.

5. The apparatus of claim 1, wherein said first and second planar substrates each comprise:
a substrate of insulating material having formed thereon said flat conductive concentric rings, wherein each said concentric ring on one said substrate appears as a mirror image of the corresponding concentric ring on said facing substrate.

6. The apparatus of claim 5, wherein said substrate further comprises:
a printed circuit board having said conductive rings formed thereon.

7. The apparatus of claim 1, wherein said first and second planar substrates each comprise:
a substrate of insulating material having formed thereon said flat conductive rings, wherein each said conductive ring on one said substrate appears as a mirror image of the conductive ring on said facing substrate.

8. The apparatus of claim 7, wherein said substrate further comprises:
a printed circuit board having said conductive rings formed thereon.

9. The apparatus of claim 1, wherein said defined gap comprises:
a uniform spacing dimension between said first and second substrates, said defined gap further having a characteristic dielectric constant.

10. The apparatus of claim 1, wherein said conductive rings include connections to circuitry associated with said proximate first or second substrate.

11. The apparatus of claim 1, wherein said first and second flat conductive rings comprise flat conductive rings having equal areas.

12. A capacitive signal coupling apparatus, comprising:
first and second planar substrates disposed in facing, spaced apart relationship across a defined gap and supported at a central point thereof on a common axis, wherein one said planar substrate is disposed to rotate with respect to the other said planar substrate;
wherein each said planar substrate includes a flat conductive ring of same dimension and area on its facing surface centered on said axis such that said flat conductive rings are disposed in direct facing relationship with each other across said defined gap.
